(19) United States
(12) Patent Application Publication
(10) Pub. No.: US 2026/0310111 A1
(43) Pub. Date: Oct. 8, 2026

(54) POSITIVELY CHARGEABLE TONER AND TWO-COMPONENT DEVELOPER CONTAINING POSITIVELY CHARGEABLE TONER

(71) Applicant: KYOCERA Document Solutions Inc., Osaka (JP)

(72) Inventors: Ryo YAMADA, Osaka (JP); Masanori SUGAHARA, Osaka (JP); Masashi YAMASHITA, Osaka (JP)

(73) Assignee: KYOCERA Document Solutions Inc., Osaka (JP)

(21) Appl. No.: 19/636,689

(22) Filed: Apr. 1, 2026

(30) Foreign Application Priority Data
Apr. 8, 2025 (JP) 2025-063876

(51) Int. Cl. G03G 9/093; G03G 9/08; G03G 9/087; G03G 9/09; G03G 9/107; G03G 9/113

(52) U.S. Cl. CPC G03G 9/09321; G03G 9/0819; G03G 9/08755; G03G 9/0918; G03G 9/09342; G03G 9/09364; G03G 9/108; G03G 9/1136

(57) ABSTRACT

Positively chargeable toner has toner particles each including a toner base particle and an external additive attached to the surface of the toner base particle. The external additive includes a resin fine particle. The resin fine particle has a number average primary particle size of 30 nm or more but 70 nm or less. The resin fine particle has a detachment rate of 30% or less as observed when the toner particles dispersed in a water-based dispersion liquid containing a nonionic surfactant are subjected to ultrasonic treatment under ultrasonic vibration for one minute at a power of 100 W and a frequency of 28 kHz. The resin fine particle has a shear adhesion at 25° C. of 10 kPa or more but 30 kPa or less as measured using a powder layer shear force tester.

### INCORPORATION BY REFERENCE

This application is based on and claims the benefit of priority from Japanese Patent Application No. 2025-063876 filed on Apr. 8, 2025, the contents of which are hereby incorporated by reference.

### BACKGROUND

The present disclosure relates to positively chargeable toner and two-component developer containing the positively chargeable toner.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image. Typically, as toner for use in such electrophotography, a binder resin such as a thermoplastic resin is blended with a colorant, a charge control agent, a release agent, a magnetic material, and the like and the mixture is then subjected to kneading, pulverization, and classification to obtain toner particles (toner base particles) with an average particle size of 5 μm or more but 10 μm or less. Then, for the purposes of giving the toner fluidity, giving it satisfactory charging properties, and improving the cleaning properties of the toner against a photosensitive drum, an inorganic fine powder such as silica or titanium oxide is externally added to the toner base particles.

An external additive on the surface of toner sinks, comes off, or otherwise changes under mechanical stress caused by being stirred in a developing unit. One generally known method of suppressing the change such as sinking in and coming-off of the external additive is to use an external additive with a large diameter as spacer particles. Silica can be used as spacer particles, but, using it for positively chargeable toner necessitates positive chargeability treatment for the silica particles themselves to give them positive chargeability. This positive chargeability treatment causes defects (such as fogging) related to electrostatic charging.

In these days, thick recording media and embossed sheets treated to have an irregular surface as by embossing are increasingly used for business cards, covers of printed matter, and the like. Inconveniently, however, with thick or embossed sheets, insufficient transfer of toner can cause image dropouts. To cope with this, in order to reduce the adhesion of toner to an intermediate transfer member, an intermediate transfer member has been developed that has a base layer in which a conductive agent is dispersed and that has a silicon oxide film containing carbon as its surface layer. Reducing the adhesion of toner to the intermediate transfer member too much, however, inconveniently makes the toner in contact with the intermediate transfer member tend to move under the pressure during primary transfer or secondary transfer and thus makes the toner layer tend to collapse, degrading the quality of thin lines, letters, and the like. Hence degraded fine-line reproductivity in images.

### SUMMARY

According to one aspect of the present disclosure, positively chargeable toner has toner particles each including a toner base particle and an external additive attached to the surface of the toner base particle. The external additive includes a resin fine particle. The resin fine particle has a number average primary particle size of 30 nm or more but 70 nm or less. The resin fine particle has a detachment rate of 30% or less as observed when the toner particles dispersed in a water-based dispersion liquid containing a nonionic surfactant is subjected to ultrasonic treatment under ultrasonic vibration for one minute at a power of 100 W and a frequency of 28 kHz. The resin fine particle has a shear adhesion at 25° C. of 10 kPa or more but 30 kPa or less as measured using a powder layer shear force tester.

### BRIEF DESCRIPTION OF THE DRAWINGS

FIG. 1 is a diagram showing one example of the sectional structure of positively chargeable toner according to the present disclosure.

FIG. 2 is a diagram schematically showing the behavior of an external additive at an edge part of a cleaning blade when the cleaning blade cleans the surface of a photosensitive drum, showing a configuration of the present disclosure containing, as the external additive, resin fine particles that satisfy the conditions of number average primary particle size, shear adhesion, and detachment rate after ultrasonic treatment.

FIG. 3 is a diagram schematically showing the behavior of the external additive at the edge part of the cleaning blade when the cleaning blade cleans the surface of the photosensitive drum, showing a conventional example containing, as the external additive, resin fine particles that do not satisfy the conditions of number average primary particle size, shear adhesion, and detachment rate after ultrasonic treatment.

FIG. 4 is a graph showing one example of powder layer yield locus.

### DETAILED DESCRIPTION

A description will be given below of an embodiment according to the present disclosure. Unless otherwise defined, a result of evaluation (i.e., a value related to a shape, property, or the like) with respect to a powdery substance (specifically, toner core particle, toner base particle, external additive, toner, and the like) is given as a number average of values obtained by measuring respectively for an appropriate number of average particles selected from the powdery substance. Unless otherwise defined, a measured value of the number average primary particle size of a powdery substance or the volume median diameter (D50) of a powdery substance is a value measured using a Multisizer 4 (manufactured by Beckman Coulter, Inc.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂═C(CH₃)—CO—) collectively.

Toner according to the embodiment can be used, for example, as positively chargeable toner suitably for development of electrostatic latent images. The toner according to the embodiment is a powdery substance containing a plurality of toner particles (each a particle configured as described later). The toner according to the embodiment is mixed with carrier using a mixing apparatus (e.g., a ball mill) to prepare two-component developer. To form high-quality images, it is preferable to use ferrite carrier as the carrier.

To form high-quality images over a long period, it is preferable to use magnetic carrier particles that have a carrier core and a resin layer coating the carrier core. To produce magnetic carrier particles, the carrier core can be formed with a magnetic material (e.g., ferrite) or the carrier core can be formed with resin having magnetic particles dispersed in it. Or, magnetic particles can be dispersed in the resin layer coating the carrier core. To form high-quality images, the amount of toner in two-component developer is preferably 5 mass parts or more but 15 mass parts or less for 100 mass parts of carrier. Positively chargeable toner is charged positive by friction with carrier.

The toner particles of the toner according to the embodiment have a toner base particle and an external additive attached to the surface of the toner base particle. That is, the toner particle before the external additive attaches to it is referred to as toner base particle. If the toner base particle has a shell layer, the particle before the shell layer is formed on it is referred to as the toner core particle. If the toner base particle has no shell layer, the toner base particle alone is also referred to as the toner core particle.

The toner according to the embodiment can be used to form an image, for example, on an electrophotographic apparatus (image forming apparatus). One example of an image forming method on an electrophotographic apparatus will be described below.

First, based on image data, an electrostatic latent image is formed on a photosensitive member (e.g., a superficial part of a photosensitive drum). Next, the formed electrostatic latent image is developed with developer containing toner. In the development process, toner (e.g., toner electrostatically charged by friction with carrier or a blade) on a development sleeve (e.g., a superficial part of a development roller in the developing device) disposed near the photosensitive member is attached to the electrostatic latent image to form a toner image on the photosensitive member. In the subsequent transfer process, the toner image on the photosensitive member is directly transferred to a recording medium (e.g., sheet); or it is primarily transferred to an intermediate transfer member (e.g., a transfer belt) and then the toner image on the intermediate transfer member is secondarily transferred to the recording medium. Then, the toner is heated to fix the toner to the recording medium. As a result, an image is formed on the recording medium. By superposing on each other toner images of four colors, for example, black, yellow, magenta, and cyan, it is possible to form a full-color image.

### [1. Basic Configuration of Toner]

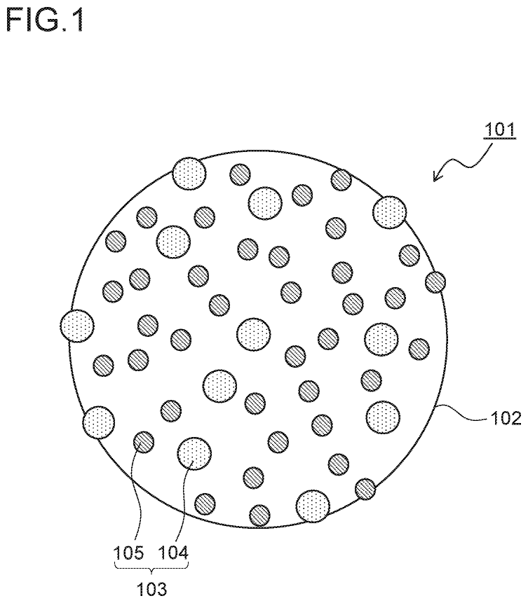

FIG. 1 is a diagram showing one example of the sectional structure of positively chargeable toner 101 according to the present disclosure. As shown in FIG. 1, the positively chargeable toner (hereinafter often referred to simply as toner) 101 according to the present disclosure has a toner base particle 102 and an external additive 103 attached to the surface of the toner base particle 102. The toner base particle 102 at least contains a binder resin and a colorant. The external additive 103 contains resin fine particles 104 and inorganic fine particles 105. The inorganic fine particles 105 are, for example, silica particles and are optional components.

The resin fine particles 104 are used as spacer particles. The number average primary particle size of the resin fine particles 104 is 30 nm or more but 70 nm or less. If the resin fine particles 104 have a number average primary particle size less than 30 nm, they are easy to fix to the surface of the toner base particle 102 but are less effective as a spacer and thus less effective in preventing the sinking of the resin fine particles 104. As a result, the resin fine particles 104 and other external additives (not shown) such as the inorganic fine particles 105 (silica particles) sink to promote deterioration of toner and aggravate toner scattering and image density variation, making it impossible to produce images with stabled quality.

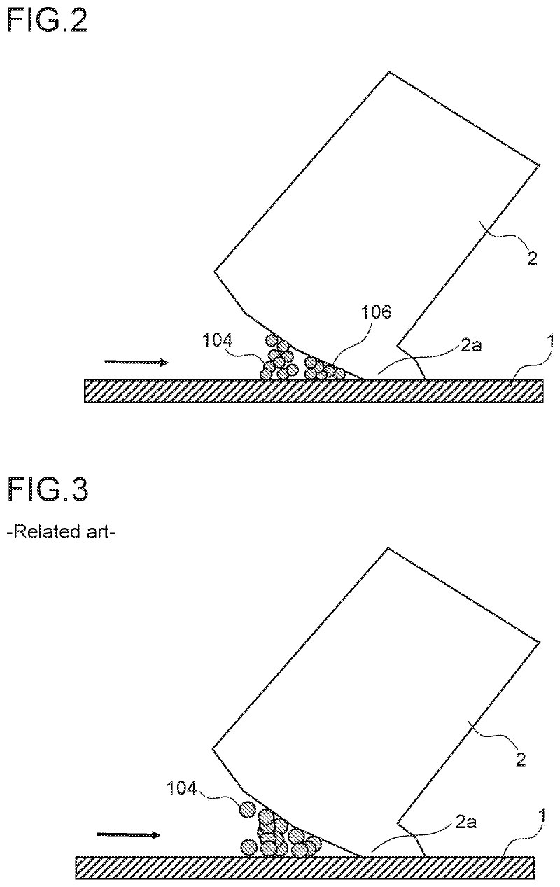

On the other hand, if the resin fine particles 104 have a number average primary particle size more than 70 nm, they are difficult to fix to the surface of the toner base particle 102 and more of them come off. This impedes the satisfactory formation of a stationary layer 106 (see FIG. 2) in a nip portion (hereinafter often referred to as the cleaning portion) between a photosensitive drum 1 and a cleaning blade 2 (for both, see FIG. 2) and leads to poor cleaning, making image dropouts more likely. In addition, released resin fine particles 104 can contaminate carrier or contaminate members in an image forming apparatus.

In the toner 101 according to the present disclosure, the resin fine particles 104 have a shear adhesion in a predetermined range, as measured on a powder layer shear force tester. Specifically, the shear adhesion of the resin fine particles 104 at 25° C. measured by using a powder layer shear force tester (NS-S500, manufactured by Nano Seeds Corporation) is 10 kPa or more but 30 kPa or less.

The shear adhesion is calculated from a powder layer yield locus representing the relationship between shear stress and vertical stress generated when a powder layer of the resin fine particles 104 is sheared with vertical stress applied to it, and means the shear stress when no vertical stress is acting. That is, it can be understood as an index of the particle-to-particle adhesion in the resin fine particles 104.

If the shear adhesion at 25° C. is less than 10 kPa, the formation of the stationary layer 106 at the cleaning portion is difficult. This leads to significantly poor cleaning performance, causing image dropouts. On the other hand, if the shear adhesion at 25° C. is more than 30 kPa, the adhesion of the resin fine particles 104 is so strong that toner adheres to the photosensitive drum 1. This degrades the transferring properties of the toner, making it impossible to form images stably.

In addition, in the toner 101 according to the present disclosure, the resin fine particles 104 have a detachment rate equal to or less than a predetermined value, as observed when the toner 101 dispersed in a water-based dispersion liquid containing a nonionic surfactant is subjected to ultrasonic treatment. Specifically, the resin fine particles 104 have a detachment rate of 30% or less after ultrasonic treatment under ultrasonic vibration for one minute at a power of 100 W and a frequency of 28 kHz.

If the resin fine particles 104 have a detachment rate of 30% or less, detached resin fine particles 104 form the stationary layer 106 at the cleaning portion. This leads to improved performance of scraping the external additive and toner, resulting in improved performance of cleaning of the photosensitive drum by the cleaning blade. On the other hand, if the resin fine particles 104 have a detachment rate more than 30%, they are less effective as a spacer. This promotes deterioration of toner and sinking of the external additive into the toner base particle and thus aggravates toner scattering and image density variation, making it impossible to form images stably. In addition, this impedes the satisfactory formation of the stationary layer 106 at the cleaning portion and thus leads to poor cleaning performance, making image dropouts more likely.

FIGS. 2 and 3 schematically show the behavior of the external additive at an edge part 2a of the cleaning blade 2 when the cleaning blade 2 cleans the surface of the photosensitive drum 1. FIG. 2 shows a configuration of the present disclosure containing, as the external additive, the resin fine particles 104 that satisfy the above-mentioned conditions of the number average primary particle size, the shear adhesion, and the detachment rate after ultrasonic treatment. FIG. 3 shows a conventional example containing, as the external additive, resin fine particles 104 that do not satisfy the above-mentioned conditions of the number average primary particle size, the shear adhesion, and the detachment rate after ultrasonic treatment. The arrow in the figures indicates the direction in which the surface of the photosensitive drum 1 moves.

With the addition, as the external additive, of the resin fine particles 104 that satisfy the conditions of the number average primary particle size, the shear adhesion, and the detachment rate, as shown in FIG. 2, a stationary layer 106 of the resin fine particles 104 is formed at the edge part 2a. This prevents the resin fine particles 104 from reaching the edge part 2a (entering the nip part between the photosensitive drum 1 and the cleaning blade 2). Thus, it is possible to prevent an agglomeration of the resin fine particles 104 from pushing up the cleaning blade 2.

With the addition of the resin fine particles 104 that do not satisfy the conditions of the number average primary particle size, the shear adhesion, and the detachment rate, as shown in FIG. 3, no stationary layer 106 of the resin fine particles 104 is formed. Thus, an agglomeration of the resin fine particles 104 reaches the edge part 2a of the cleaning blade 2 under the conveyance force of the photosensitive drum 1 to push up the cleaning blade 2. As a result, the external additive slips across the edge part 2a.

### [2. Material of Toner]

Next, a description will be given of the essential or optional components of the toner according to the present disclosure. The toner core particle contains, in the binder resin, at least a colorant. It can further contain, as necessary, a release agent, a charge control agent, a magnetic powder, and the like in the binder resin, and can have a shell layer formed on the surface of the toner core particle. In the toner according to the present disclosure, the toner core particle (toner base particle) has its surface treated with an external additive.

A description will be given below, one by one, of the binder resin, the release agent, the charge control agent, the colorant, and the magnetic powder that form the toner core particle, a shell material for cases where a shell layer is formed on the toner core particle, the external additive externally added to the toner core particle (toner base particle), and a method of producing the toner according to the present disclosure.

### (Binder Resin)

The toner core particle that forms the toner according to the present disclosure contains a binder resin. The binder resin that can be contained in the toner particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties to sheets, preferably, at least one of a polyester resin and a styrene-acrylic-based resin is used, more preferred being a polyester resin. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra(methylene carboxyl) methane, 1,2,7,8-octane tetracarboxylic acid, pyromellitic acid, and empole trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

When the binder resin is a polyester resin, the softening point of the polyester resin is preferably 70° C. or more but 130° C. or less, and more preferably 80° C. or more but 120° C. or less. For improved mechanical strength of the toner core particles and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, it is preferable to use a thermoplastic resin for its satisfactory fixing properties to sheets. Here, a thermoplastic resin can be used not only singly but also with a cross-linking agent or a thermosetting resin added to it. Adding a cross-linking agent or a thermosetting resin so that the binder resin partly has a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tend to be poor. If the glass transition point is too low, the heat-resistant preservation properties of the toner tend to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200, manufactured by Seiko Instruments Inc.), as a measuring instrument. 10 mg of a measurement sample is put in an aluminum pan while an empty aluminum pan is used as a reference. From the endothermic curve of the binder resin plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Release Agent)

For the purpose of improving its fixing properties and anti-offsetting properties, the toner core particle can contain a release agent. The type of release agent that can be added to the toner core particle is not limited within the scope consistent with the object of the present disclosure. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such a release agent to the toner core particle helps more effectively suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax C1 (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner core particle, preferably 1 mass % or more but 10 mass % or less. Using too small an amount of release agent can result in less-than-expected suppression of offsetting or image smearing in image formation; using too large an amount of release agent can result in fusing-together of toner particles and hence poor heat-resistant preservation properties of toner.

### (Colorant)

The toner core particle can contain a colorant. As the colorant that can be contained in the toner core particle, any known pigment or dye that suits the color of the toner can be used. Specific examples of colorants that can be suitably added to the toner include: black pigments such as carbon black, acetylene black, lamp black, aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, permanent red 4R, lithol red, pyrazolone red, Watchung red calcium salt, lake red D, brilliant carmine 6B, eosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated Victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these colorants can be used in combination for the purpose of adjusting the toner to the desired hue and the like.

The amount of colorant used is not particularly limited within the scope consistent with the object of the present disclosure. Specifically, the amount of colorant used is, relative to the total mass of the toner core particle, preferably 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner core particle can contain a charge control agent for the purposes of improving the charge level of the toner and the charge response properties as the index of whether it can be charged to a predetermined charge level in a short time, and thereby obtaining toner with excellent durability and stability. Since the toner according to the present disclosure is a positively chargeable toner used in development with the toner positively charged, a positively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins is not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is, relative to the total mass of the toner core particle, preferably 0.1 mass % or more but 10 mass % or less. Using too small an amount of charge control agent makes it difficult to stably charge the toner with a predetermined polarity. This can lead to a lower-than-expected value in the image density of the formed image and make it difficult to maintain satisfactory image density for a long period. Also, the charge control agent is then difficult to disperse evenly, and this tends to cause fogging in the formed image and contamination of a latent image carrying member with toner components. Using too large an amount of charge control agent can lead to poorer resistance to environment and this tends to cause image faults in the formed image due to insufficient charging under high temperature and high humidity, contamination of a latent image carrying member with toner components, and the like.

### (Magnetic Powder)

The toner core particle can contain a magnetic powder. Suitably usable as the material of the magnetic powder is, for example, a ferromagnetic metal (more specifically, iron, cobalt, nickel, an alloy containing one or more of these metals, or the like), a ferromagnetic metal oxide (more specifically, ferrite, magnetite, chromium dioxide, or the like), or a material subjected to ferromagnetization (more specifically, a carbon material made ferromagnetic by heat treatment, or the like). To suppress the elution of a metal ion (e.g., iron ion) from the magnetic powder, it is preferable to use surface-treated magnetic particles as the magnetic powder. One type of magnetic powder can be used singly or a plurality of types of magnetic powder can be used in combination.

The toner core particle can have, if so desired, its surface coated by a shell layer. If the toner core particle has a shell layer formed on it, the shell layer is formed of resin fine particles. To give the shell layer an adequate level of surface absorption, it is particularly preferable that the shell layer include a resin film composed mainly of an agglomeration of resin fine particles with a glass transition point of 50° C. or more but 100° C. or less; that heat-resistant particles forming the resin film have a number average circularity of 0.55 or more but 0.75 or less; that the heat-resistant particles contain a resin having one or more types of repeating unit derived from a styrene-based monomer, a repeating unit having an alcoholic hydroxyl group, and a repeating unit derived from a nitrogen-containing vinyl compound; and that the repeating unit with the highest mass proportion among the repeating units in the resin contained in the heat-resistant particle is a repeating unit derived from a styrene-based monomer.

With regard to the shell layer described above (i.e., the resin film composed mainly of an agglomeration of heat-resistant particles), to give the toner satisfactory heat-resistant preservation properties, fixing properties, and charging properties, preferably, the shell layer has a thickness of 10 nm or more but 35 nm or less. The thickness of the shell layer can be measured, by using a commercially available image analysis software (e.g., “WinROOF;” developed by MITANI CORPORATION), analyzing a TEM (transmission electron microscopy) image of a section of the toner particle. If, in one toner particle, the shell layer has an uneven thickness, this can be coped with by measuring the thickness of the shell layer at four points evenly apart from each other (specifically, four points at which two straight lines drawn to orthogonally intersect substantially at the center of a section of the toner particle cross the shell layer) and taking the arithmetic average of the obtained four measurement values as the evaluation value (the thickness of the shell layer) of that toner particle. The boundary between the toner core particle and the shell layer can be recognized, for example, by selectively staining only the shell layer of the toner core particle and the shell layer. If, in the TEM image, the boundary between the toner core particle and the shell layer is obscure, TEM and electron energy loss spectroscopy (EELS) can be used in combination to map elements characteristic of the shell layer. This clarifies the boundary between the toner core particle and the shell layer.

With regard to the shell layer described above (i.e., the resin film composed mainly of an agglomeration of heat-resistant particles), to give the toner satisfactory heat-resistant preservation properties, fixing properties, and charging properties, preferably, the shell layer covers 50% or more but 80% or less of the area of the surface region of the toner core particle. The proportion in area of the region covered by the shell layer out of the surface region of the toner core particle can be determined by obtaining an image of the surface of the toner particle (e.g., a previously stained toner particle) using an electron microscope and analyzing the obtained image using commercially available image analysis software.

### (External Additive)

In the toner according to the present disclosure, the surface of the toner core particle is treated with an external additive. In the following description, the toner core particle before being treated with the external additive is referred to also as toner base particle. The toner according to the present disclosure includes as the external additive resin fine particles.

### (Resin Fine Particles)

The resin fine particles have a number average primary particle size of 30 nm or more but 70 nm or less. The resin fine particles have a shear adhesion at 25° C. of 10 kPa or more but 30 kPa or less. The resin fine particles have a detachment rate after ultrasonic treatment of 30% or less.

The material of the resin fine particles is not particularly limited so long as the number average primary particle size, the shear adhesion, the detachment rate after ultrasonic treatment can be adjusted within the above-described ranges. The resin fine particles are surface-treated with a surfactant. Surface-treating the resin fine particles with a surfactant helps suppress agglomeration of the resin fine particles.

While, as a surfactant, any of cationic surfactants, anionic surfactants, and nonionic surfactants can be used, if the resin fine particles are surface-treated with an anionic surfactant or a nonionic surfactant, when the resin fine particles are externally added to the toner base particle, the positive chargeability of the toner is slightly reduced. Thus, it is preferable to use a cationic surfactant.

Examples of cationic surfactants include cetyl trimethyl ammonium chloride. Examples of anionic surfactants include dodecyl benzene sulfonate. Examples of nonionic surfactants include polyvinyl alcohol.

Note that the resin fine particles can be subjected to any other surface treatment. Examples of other surface treatment include hydrophobization treatment, positive charging treatment, and conductive treatment.

If the toner base particle contains a polyester resin as a binder resin and if a resin constituting the resin fine particle is a cross-linked resin, to adjust the number average primary particle size, the shear adhesion, and the detachment rate after ultrasonic treatment within the above-described ranges, preferably, the cross-linked resin is a polymer of a styrene-based monomer, an acrylic acid-based monomer, and a cross-linking agent having two or more unsaturated bonds (hereinafter such a polymer is often referred to as the specific cross-linked polymer).

Examples of styrene-based monomers for synthesis of the specific cross-linked polymer include styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene.

Examples of acrylic acid-based monomers for synthesis of the specific cross-linked polymer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, and phenyl (meth)acrylate.

Examples of cross-linking agent having two or more unsaturated bonds for synthesis of the specific cross-linked polymer include N,N′-methylene bisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate, and 1,6-hexanediol dimethacrylate.

To obtain toner that excels more in charging stability and heat-resistant preservation properties, preferably, the cross-linking agent having two or more unsaturated bonds is ethylene glycol dimethacrylate.

To obtain toner that excels even more in charging stability and heat-resistant preservation properties, preferably, the binder resin in the toner base particle is a polyester resin and the resin constituting the resin fine particle is a polymer (cross-linked polymer) of styrene, methyl methacrylate, and ethylene glycol dimethacrylate.

The method for forming the resin fine particles is not particularly limited. Examples of the method for forming the resin fine particles include emulsion polymerization, seed polymerization, and dispersion polymerization. In the embodiment, a commercially available product can be used as the resin fine particles.

In combination with the resin fine particles described above, another external additive can be used. The type of external additive that can be used together with the resin fine particles is not particularly limited within the scope consistent with the object of the present disclosure and thus can be selected appropriately from external additives known to be used in toner. Examples of other suitable external additives include inorganic fine particles.

Specific examples of inorganic fine particles include metal oxides and the like, such as silica, alumina, titanium oxide, magnesium oxide, zinc oxide, strontium titanate, and barium titanate. Of these types of particles, one type can be used singly or two or more can be used in combination. Preferably, the average particle size of the inorganic particle is 10 nm or more but 100 nm or less.

In a case where the toner according to the present disclosure is blended with carrier to be used as two-component developer, using as the carrier silicone-coated carrier coated with silicone resin helps suppress carrier contamination due to the attachment of the external additive to the carrier. This is possible because the silicone resin in the coat layer has low adhesion and because the resin fine particles (spacer particles) in the toner can be restrained from attaching to the carrier.

### [Production Method for Toner]

Next, a production method for the toner according to the present disclosure will be described. The production method for the toner includes a production method for a toner core particle and an external additive treatment method for attaching an external additive to the surface of the toner base particle. The production method for the toner core particle is not particularly limited so long as it forms the toner core particle with a predetermined structure. As necessary, a toner core particle coated with a shell layer can be used as the toner base particle. As a suitable production method for the positively chargeable toner described above, a method for producing the toner core particle, a method for forming the shell layer, and the method for external addition treatment will be described one by one below.

### (Method for Producing the Toner Core Particle)

The method for producing the toner core particle is not particularly limited so long as it can satisfactorily disperse any optional components such as a colorant, a release agent, a charge control agent, and a magnetic powder in the binder resin. Examples of suitable methods for producing the toner core particle include a pulverization method and an agglomeration method.

In the pulverization method, the binder resin and any components such as a colorant, a release agent, a charge control agent, and a magnetic powder are mixed using a mixer and the like; then the binder resin and the components blended in the binder resin are melted and kneaded using a kneader such as a uniaxial or biaxial extruder; and the cooled kneaded product is pulverized and classified. While the average particle size of the toner core particle is not particularly limited within the scope consistent with the object of the present disclosure, generally it is preferably 5 μm or more but 10 μm or less.

In the agglomeration method, in an aqueous medium containing fine particles of each of the binder resin, a release agent, a charge control agent, and a colorant, these fine particles are agglomerated until they have a predetermined particle size. This forms an agglomerate particle containing the binder resin, the release agent, the charge control agent, and the colorant. Subsequently, the obtained agglomerate particle is heated so that the components in the agglomerate particle coalesce. This yields a toner core particle with a predetermined particle size.

### (Method for Forming Shell Layer)

To coat the surface of the toner core particle with the shell layer, resin fine particles are attached to the surface of the toner core particle to form the shell layer.

The method will be described more specifically. First, in a mixing apparatus, hydrochloric acid is added to ion-exchange water to prepare an aqueous medium with weak acidity (e.g., with a pH value selected from the range of three or more but five or less). Subsequently, to the aqueous medium with the so adjusted pH value, a dispersion liquid (suspension) of resin fine particles as a shell material and the toner core particle are added.

Subsequently, while the mixture liquid containing the shell material and the toner core particle is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, the mixture liquid is, while being stirred, held at the predetermined holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that the particles of the external additive do not sink in the toner base particle.

The toner according to the present disclosure described above excels in fixing properties and heat-resistant preservation properties. In cases where images are formed for a long period in various environments including a high-temperature high-humidity environment and low-temperature low-humidity environment, the toner can be electrostatically charged to a desired charge amount. Thus, the images can be formed with the desired density. Accordingly, the toner according to the present disclosure can be suitably used in a variety of image forming apparatuses. Now, the effects of the present disclosure will be described more specifically by way of examples. The present disclosure is not limited in any way by those examples.

### EXAMPLES

### Production Example 1

### (Production of Polyester Resin)

Non-crystalline polyester resin for use as the binder resin of the toner core particle was synthesized in the following method. A reaction vessel equipped with a thermometer (thermocouple), a dehydration tube, a nitrogen introduction tube, and a stirrer (stirring blades) was set in an oil bath. BPA-EO (bisphenol A ethylene oxide adduct), terephthalic acid, and a catalyst (dibutyltin oxide) were put into the reaction vessel. After nitrogen substitution inside the reaction vessel, while the contents were being stirred, the temperature in the reaction vessel was raised to 220° C. Then, in a nitrogen atmosphere, under the condition of a temperature of 220° C., while byproduct water was distilled away, the contents in the reaction vessel were polymerized for eight hours. The pressure in the reaction vessel was decreased and then the contents in the reaction solution was polymerized for another one hour in a reduced-pressure atmosphere (a pressure of 60 mmHg), under the condition of a temperature of 220° C. Subsequently, the temperature in the reaction vessel was lowered to 210° C. and then 336 g of trimellitic acid anhydride was added into the reaction vessel. Then the contents in the reaction vessel were reacted under the conditions of a reduced-pressure (a pressure of 60 mmHg) and a temperature of 210° C. After that, the reacted product was taken out of the reaction vessel and was then cooled to obtain non-crystalline polyester resin (acid value: 5.6 mgKOH/g, softening point (Tm): 120° C., glass transition point (Tg): 56° C., number average molecular weight (Mn): 1500, mass average molecular weight (Mw): 45000).

### Production Example 2

### (Production of Toner Base Particles)

The following were mixed using an FM mixer (FM-10B, manufactured by NIPPON COKE & ENGINEERING CO., LTD.) to obtain a mixture: as a binder resin, 100 mass parts of the non-crystalline polyester resin obtained in production example 1; as a colorant, 4 mass parts of copper phthalocyanine blue pigment (C.I. Pigment Blue 15:3); as a release agent, 5 mass parts of ester wax (Nissan Electol WEP-3, manufactured by NOF CORPORATION); and as a charge control agent, 1 mass part of a quaternary ammonium salt (BONTRON (registered trademark) P-51, manufactured by ORIENT CHEMICAL INDUSTRIES CO., LTD.). Then, the mixture was melted and kneaded using a biaxial extruder (PCM-30, manufactured by IKEGAI CO., LTD.) to obtain a kneaded product. The melt-kneading was carried out under the conditions of a set temperature of 120° C., a rotation rate of 150 rpm, and a processing rate of 5 kg/hour. The kneaded product was pulverized using a mechanical pulverizer (Turbomill, manufactured by FREUND-TURBO CORPORATION) to obtain a pulverized product. The pulverized product was then classified using a classifier (Elbow Jet Model EJ-LABO, manufactured by Nittetsu Mining Co., Ltd.) to obtain toner base particles (toner core particles) with a volume average particle size (D50) of 6.8 μm. The volume average particle size of the toner base particle was measured using a Coulter Counter Multisizer 3 (manufactured by Beckman Coulter, Inc.).

### Production Example 3

### (Production of Resin Fine Particles)

28 mass parts of styrene, 42 mass parts of acrylonitrile, 30 mass parts of ethylene glycol dimethacrylate, 4.5 mass parts of potassium peroxide (water-soluble polymerization initiator), 100 mass parts of ion exchange water, and 2.0 mass parts of a cationic surfactant (cetyl trimethyl ammonium chloride) were loaded into a round bottom flask and were stirred with an anchor-shaped stirring blade at 100 rpm. The mixture was subjected to emulsion polymerization by soap-free polymerization at 70° C. for eight hours to obtain a dispersion liquid of resin fine particles.

The obtained dispersion liquid was purified with an ultrafiltration device and then the filtrate was dried by spray-drying to produce resin fine particles. The particle diameter was adjusted by controlling the nozzle aperture diameter and the spraying rate to produce resin fine particles A. Resin fine particles A had an average primary particle size of 42 nm as measured on a scanning electron microscope (JSM-7600F, manufactured by JEOL LTD.).

Resin fine particles B to S were obtained through a procedure similar to that for resin fine particles A except that the types and the blending amounts of monomers and the stirring rate were changed. With obtained resin fine particles A to S, their shear adhesion was measured by a method described below.

### (Measurement of Shear Adhesion of Resin Fine Particles)

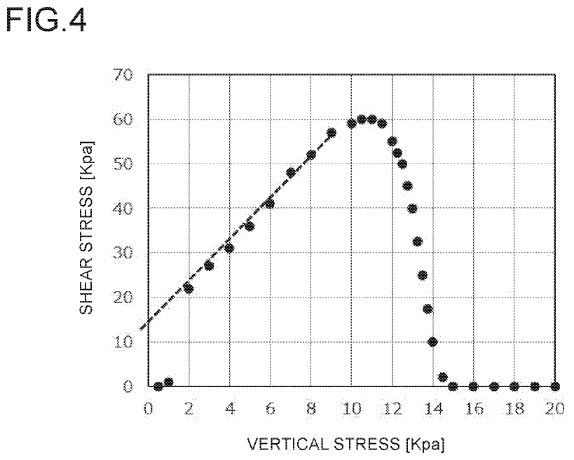

A powder layer shear force tester (NS-S500, manufactured by Nano Seeds Corporation) was used to carry out measurement in conformity with JIS (Japanese Industrial Standards) Z8835:2016. More specifically, the resin fine particles were loaded in shear cells, then the top surface of the powder layer was leveled, and then, under a target pushing load of 100 N, the cells started to be slid horizontally; meanwhile vertical stress and shear stress were measured over time to determine a powder layer yield locus. After that, from the intersection of the powder layer yield locus and the axis of shear stress (vertical axis), the shear adhesion was calculated. FIG. 4 shows one example of the powder layer yield locus. In the example in FIG. 4, the shear adhesion was 15 kPa.

### Production Example 4

### (Production of Toner)

100 mass parts of the toner base particles obtained in production example 2, 1.0 mass part of resin fine particles A obtained in production example 3, and 1.5 mass parts of hydrophobic silica particles (AEROSIL RA-200H, manufactured by NIPPON AEROSIL CO., LTD.) were mixed under the condition of 4,000 rpm for five minutes using an FM mixer with a volume of 10 L (FM-10B, manufactured by Nippon Coke & Engineering Co., Ltd.) to adjust the calculated coverage ratio of the resin fine particles relative to the surface of the toner base particle to 30%. As the hydrophobic silica particles, dry silica particles (AEROSIL RA-200H, manufactured by NIPPON AEROSIL CO., LTD., number average primary particle size: 12 nm) surface-treated with a trimethylsilyl group and an amino group were used. The obtained mixture was sieved using a sieve with a mesh of 200 (a sieve opening of 75 μm) to obtain toner of Practical Example 1 of the present disclosure.

Toners of Practical Examples 2 to 6 and Comparative Examples 1 to 13 were obtained using different kinds of resin fine particles (A to S).

### Production Example 5

### (Production of Carrier)

The following were mixed using a homo-mixer to obtain a coating liquid: 361.2 g of a silicone resin solution (KR-255, manufactured by Shin-Etsu Chemical Co., Ltd.; solid concentration: 50 mass %); 36.2 g of barium titanate (BT-01, manufactured by SAKAI CHEMICAL INDUSTRY CO., LTD.; number average primary particle size: 304 nm); 14.4 g of carbon black (KETJENBLACK EC-300J, manufactured by Lion Specialty Chemicals Co., Ltd., number average primary particle size: 39.5 nm); and 1444.8 g of toluene.

While, using a fluidized bed-coating machine (model FD-MP-01D, manufactured by Powrex Corporation), 5000 g of carrier core were kept flowing, the coating liquid was sprayed to the carrier cores. In this way, the carrier cores coated with the coating liquid were obtained. The coating was carried out under the conditions of an aeration temperature of 75° C., an aeration air flow rate of 0.3 m³/min, and a rotor rotation rate of 400 rpm. Used as the carrier cores were manganese ferrite cores (manufactured by DOWA IP CREATION CO., LTD.; volume median diameter: 40 μm, saturation magnetization: 67 emu/g). The carrier cores coated with the coating liquid were baked for one hour at 200° C. using an electric furnace to obtain silicone-coated carrier having a coat layer formed on the surface of a carrier core.

### Production Example 6

### (Production of Developer)

92 mass parts of the carrier obtained in production example 5 and 8 mass parts of each of the toners of Practical Examples 1 to 6 and Comparative Examples 1 to 13 obtained in production example 4 were mixed for thirty minutes using a rocking mixer (RM-10, manufactured by AICHI ELECTRIC CO., LTD.) to prepare evaluation developer (two-component developer).

[Measurement of Detachment Rate of Resin Fine Particles with Respect to Toner Base Particles]

With toners of Practical Examples 1 to 6 and Comparative Examples 1 to 13 obtained in production example 4, the detachment rate of the resin fine particles with respect to the toner base particles was measured by the following method.

### (Ultrasonic Treatment)

98 g of ion exchange water was mixed with 1 g of the toner obtained in production example 4 and 2 g of an aqueous solution of a nonionic surfactant (Emalgen (registered trademark) 120, manufactured by Kao Corporation; component: polyoxyethylene lauryl ether) with a concentration of 10 mass %. Using an ultrasonic disperser (ultrasonic mini welder P128, manufactured by ULTRASONIC ENGINEERING CO., LTD., power: 100 W, oscillation frequency: 28 kHz), ultrasonic treatment was carried out for one minute to disperse the toner in a dispersion medium (an aqueous medium containing the nonionic surfactant). This yielded a toner dispersion liquid containing toner at a concentration of 1 mass % relative to the mass (100 g) of the dispersion medium.

Subsequently, the toner dispersion liquid (pure water and the toner) was filtered (solid-liquid separation) under suction using a Buchner funnel. Then, the obtained toner (the toner after ultrasonic treatment) was dried to obtain toner after removal of released particles.

The obtained toner was observed at a 50,000× magnification using a scanning electron microscope (JSM-7600F, manufactured by JEOL LTD.) to obtain an electron microscopic image of the surface of a toner particle. The obtained electron microscopic image was segmented to calculate the coverage ratio of the resin fine particles after ultrasonic treatment. In addition, the toner before ultrasonic treatment was observed at a 50,000× magnification using the scanning electron microscope and the coverage ratio of the resin fine particles before ultrasonic treatment was calculated similarly, as above.

### (Calculation of Detachment Rate)

The detachment rate of the resin fine particles was calculated with the formula below based on the calculated coverage ratio of the resin fine particle with respect to the surface of the toner before and after ultrasonic treatment.

$$detachment rate X [ \% ] = \{ 1 - ( β / α ) \} \times 100 \qquad ( 1 )$$

α: the coverage ratio [%] of the resin fine particles before ultrasonic treatment
β: the coverage ratio [%] of the resin fine particles after ultrasonic treatment

Table 1 shows, along with the compositions of resin fine particles A to S, the number average primary particle size and shear adhesion of resin fine particles A to S and the detachment rate of resin fine particles A to S with respect to the toner base particles.

TABLE 1

| Resin | | | | | Stirring | Particle | Shear | Detachment |
|---|---|---|---|---|---|---|---|---|
| Fine | Composition (mass parts) | | | | Rate | Diameter | Adhesion | Rate |
| Particles | Styrene | AN | EGDM | Surfactant | [rpm] | [nm] | [kPa] | [%] |
| A | 22 | 42 | 36 | 2 | 100 | 42 | 10 | 30 |
| B | 28 | 45 | 27 | 2 | 100 | 42 | 30 | 30 |
| C | 22 | 42 | 36 | 2 | 106 | 30 | 10 | 30 |
| D | 28 | 45 | 27 | 2 | 106 | 30 | 30 | 30 |
| E | 22 | 42 | 36 | 2 | 86 | 70 | 10 | 30 |
| F | 28 | 45 | 27 | 2 | 86 | 70 | 30 | 30 |
| G | 22 | 42 | 36 | 2 | 111 | 20 | 10 | 30 |
| H | 28 | 45 | 27 | 2 | 111 | 20 | 30 | 30 |
| I | 22 | 42 | 36 | 2 | 81 | 80 | 10 | 30 |
| J | 28 | 45 | 27 | 2 | 81 | 80 | 30 | 30 |
| K | 40 | 20 | 40 | 2 | 106 | 30 | 5 | 30 |
| L | 40 | 20 | 40 | 2 | 86 | 70 | 5 | 30 |
| M | 32 | 48 | 20 | 2 | 106 | 30 | 40 | 30 |
| N | 32 | 48 | 20 | 2 | 86 | 70 | 40 | 30 |
| O | 40 | 20 | 40 | 2 | 111 | 20 | 5 | 30 |
| P | 32 | 48 | 20 | 2 | 111 | 20 | 40 | 30 |
| Q | 40 | 20 | 40 | 2 | 81 | 80 | 5 | 30 |
| R | 32 | 48 | 20 | 2 | 81 | 80 | 40 | 30 |
| S | 22 | 42 | 36 | 2 | 61 | 120 | 10 | 40 |

AN: acrylonitrile
EGDM: ethylene glycol dimethylether
surfactant: a cationic surfactant (cetyl trimethyl ammonium chloride)

### [Evaluation of Cleaning Properties and Charging Stability of Toner]

With each of the toners of Practical Examples 1 to 6 and Comparative Examples 1 to 13, its cleaning properties and charging stability were evaluated by the methods described below.

### (Cleaning Properties)

The evaluation developer obtained in production example 6 was loaded in a development unit in an evaluation machine (TASKalfa 7054ci, manufactured by KYOCERA Document Solutions Inc.). On the other hand, toner corresponding to the developer loaded in the development unit was loaded in a toner container in the evaluation machine. In a low-temperature low-humidity environment (temperature: 10° C., humidity: 10% RH), a pattern of vertical stripes with a printing rate of 2% was printed continuously on 10,000 A4-sized sheets of plain paper. Then, a half-tone image was printed on the whole face of an A3-sized printing sheet. In the obtained half-tone image, whether an image defect in the form of stripes was present or absent was checked visually. The evaluation criteria for cleaning properties were as follows:

Good: No image defect in the form of stripes observed in the half-tone image.
Poor: An image defect in the form of stripes observed in the half-tone image.

### (Toner Scattering)

Using the evaluation machine mentioned above, in a normal-temperature normal-humidity environment (temperature: 23° C., humidity: 50% RH), a test image with a printing rate of 2% was printed continuously on 10,000 A4-sized sheets of plain paper. Then, a test image with a printing rate of 20% was printed on A4-sized sheets of plain paper. After printing, toner scattered on the top face of the development unit in the evaluation machine was checked visually. The evaluation criteria for toner scattering were as follows:

Good: No toner scattering observed on the top face of the development unit.
Acceptable: Slight toner scattering observed on the top face of the development unit.
Poor: Toner scattering observed across the entire top face of the development unit.

Table 2 shows the results of evaluation of cleaning properties and toner scattering with each of the toners of Practical Examples 1 to 6 and Comparative Examples 1 to 13 along with the types of resin fine particles used in the production of the toners.

TABLE 2

| | Resin Fine | Cleaning | Toner |
|---|---|---|---|
| Toner | Particles | Properties | Scattering |
| Practical Example 1 | A | Good | Good |
| Practical Example 2 | B | Good | Good |
| Practical Example 3 | C | Good | Acceptable |
| Practical Example 4 | D | Good | Acceptable |
| Practical Example 5 | E | Good | Good |
| Practical Example 6 | F | Good | Good |
| Comparative Example 1 | G | Good | Poor |
| Comparative Example 2 | H | Good | Poor |
| Comparative Example 3 | I | Poor | Good |
| Comparative Example 4 | J | Poor | Good |
| Comparative Example 5 | K | Poor | Acceptable |
| Comparative Example 6 | L | Poor | Good |
| Comparative Example 7 | M | Poor | Acceptable |
| Comparative Example 8 | N | Poor | Acceptable |
| Comparative Example 9 | O | Poor | Poor |
| Comparative Example 10 | P | Poor | Poor |
| Comparative Example 11 | Q | Poor | Poor |
| Comparative Example 12 | R | Poor | Poor |
| Comparative Example 13 | S | Poor | Poor |

Table 2 reveals the following. Toners of Practical Examples 1 to 6, in which, as the resin fine particles externally added to the surfaces of the toner base particles, resin fine particles A to F with a number average primary particle size of 30 nm or more but 70 nm or less, with a shear adhesion of 10 kPa or more but 30 kPa or less, and with a detachment rate from the toner base particles after ultrasonic treatment of 30% or less were used, were all good in cleaning properties and were acceptable or good in toner scattering.

In particular, toners of Practical Examples 1, 2, 5, and 6, in which the number average primary particle size of the resin fine particles was 42 nm or 70 nm, were all good in toner scattering with no scattered toner observed on the top face of the development unit.

In contrast, toners of Comparative Examples 1, 2, 9, and 10, in which resin fine particles G, H, O, and P with a number average primary particle size of 20 nm were used, were poor in toner scattering. This is considered to be because, with too small a particle size of the resin fine particles, they are less effective as a spacer; as a result, the toner particles tend to attach to each other after durability printing, leading to lower charging stability.

On the other hand, toners of Comparative Examples 3, 4, 11, and 12, in which resin fine particles I, J, Q, and R with an average particle size of 80 nm were used, were poor in cleaning properties. This is considered to be because, with too large a particle size of the resin fine particles, more resin fine particles come off from the toner base particles; as a result, more of the external additive tends to slip through.

Toners of Comparative Examples 5, 6, 9, and 11, in which resin fine particles K, L, O, and Q with a shear adhesion of 5 kPa were used, and toners of Comparative Examples 7, 8, and 12, in which resin fine particles M, N, and R with a shear adhesion of 40 kPa were used, were poor in cleaning properties. This is considered to be because, with too low a shear adhesion, the formation of the stationary layer at the cleaning portion is difficult, leading to poor cleaning performance. In addition, with too strong a shear adhesion, the adhesion of the resin fine particles is so high that more resin fine particles attach to the photosensitive drum 1.

Toner of Comparative Example 13, in which resin fine particles S with a detachment rate of 40% from the toner base particles after ultrasonic treatment was used, was poor in cleaning properties and toner scattering. This is considered to be because, with too high a detachment rate of the resin fine particles, they are less effective as a spacer and promote deterioration of toner and sinking of external additive and tend to aggravate toner scattering. In addition, the resin fine particles cannot form the stationary layer at the cleaning portion, leading to poor cleaning performance.

The above results confirm the following. Setting the number average primary particle size and the shear adhesion of the resin fine particles and the detachment rate of the resin fine particles from the toner base particles after ultrasonic treatment such that they fall within predetermined ranges contributes to improvement of cleaning properties and to suppression of toner scattering.

The present disclosure finds application in positively chargeable toner for use in an electrophotographic method. Based on the present disclosure, it is possible to provide positively chargeable toner that excels in charging stability and cleaning properties and that can suppress toner scattering and image density variation.

What is claimed is:

1. Positively chargeable toner comprising toner particles each comprising:
a toner base particle; and
an external additive attached to a surface of the toner base particle,
wherein
the external additive includes a resin fine particle,
the resin fine particle has a number average primary particle size of 30 nm or more but 70 nm or less,
the resin fine particle has a detachment rate of 30% or less as observed when the toner particles dispersed in a water-based dispersion liquid containing a nonionic surfactant are subjected to ultrasonic treatment under ultrasonic vibration for one minute at a power of 100 W and a frequency of 28 kHz, and
the resin fine particle has a shear adhesion at 25° C. of 10 kPa or more but 30 kPa or less as measured using a powder layer shear force tester.

2. The positively chargeable toner according to claim 1, wherein
the resin fine particle is formed of a polymer of a styrene-based monomer, an acrylic acid-based monomer, and a cross-linking agent and is surface-treated with a surfactant.

3. The positively chargeable toner according to claim 2, wherein
the surfactant is a cationic surfactant.

4. Two-component developer comprising:
the positively chargeable toner according to claim 1; and
carrier by friction with which the positively chargeable toner is positively chargeable.
